(19) United States
(12) Patent Application Publication
(10) Pub. No.: US 2015/0213070 A1
(43) Pub. Date: Jul. 30, 2015

(54) DATA REPORT PROCESS METHOD AND DEVICE THEREOF

(71) Applicant: TENCENT TECHNOLOGY (SHENZHEN) COMPANY LIMITED, Shenzhen City (CN)

(72) Inventors: ZE JUN WU, Shenzhen (CN); CHENG TAO FAN, Shenzhen (CN); GONG WEI LI, Shenzhen (CN); GANG WANG, Shenzhen (CN); HAI YANG ZHU, Shenzhen (CN); HAI DONG JIN, Shenzhen (CN); BAI TAO HUANG, Shenzhen (CN); CUI PING WANG, Shenzhen (CN); KAI ZHU, Shenzhen (CN); XIAO LING LIN, Shenzhen (CN)

(73) Assignee: TENCENT TECHNOLOGY (SHENZHEN) COMPANY LIMITED, Shenzhen city (CN)

(21) Appl. No.: 14/680,957

(22) Filed: Apr. 7, 2015

Related U.S. Application Data
(63) Continuation of application No. PCT/CN2014/082379, filed on Jul. 17, 2014.

(30) Foreign Application Priority Data
Jul. 22, 2013 (CN) 2013103089281

(51) Int. Cl. G06F 17/30; H04L 29/08

(52) U.S. Cl. CPC G06F 17/30312; H04L 67/10; G06F 17/30011

(57) ABSTRACT

A data report process method and a device thereof are disclosed. The computer technology field is related for resolving issues that the data report of prior art which can hardly satisfy self demands of various application programs with few demonstration possibilities. The method comprises: receiving and demonstrating preset element configuration information; receiving a configuration content selected in the element configuration information by an user; establishing the data report, and configuring respective elements in the data report according to the configuration content, and the data report comprises index information; obtaining data content corresponding to respective indexes in the index information according to the index information; writing the data content in the data report. The present invention is applied to data analysis service.

### CROSS REFERENCE TO RELATED APPLICATION

This application is a continuation of International Application No. PCT/CN2014/082379, filed Jul. 17, 2014, which claims priority to CN2013103089281 filed Jul. 22, 2013.

### FIELD OF THE TECHNOLOGY

The present disclosure relates to the field of computer technology, and more particularly to a data report process method and a device thereof.

### BACKGROUND

With the constant development of computer technology, the application program run on the electrical terminal devices springs up nowadays. For a better understanding of usage conditions of various application programs, such as the condition of new user's staying or leaving of the application program, participation to the application program, profits of the application program and et cetera. The usage conditions can be demonstrated by the form of data report. As an illustration, For knowing the daily active account number, the monthly active account number, the new install account number and et cetera of the application program, the aforesaid daily active account number, the monthly active account number, the new install account number and et cetera can be demonstrated in a data report. Besides, a calculation rule can be preset to run calculations to respective indexes in the data report. Moreover, the respective indexes can be graphically demonstrated. For instance, a histogram, a pie chart and et cetera can be illustrated to demonstrate the indexes.

Generally, the data reports of prior arts are developed by the developer of the data report and preset according to the demands of most application programs. Common indexes and demonstration forms are provided. Thus, the demonstration contents of the data reports used by most of the application programs are almost the same. Demands of various application programs as regarding the data report demonstration are quite different. For instance, some of application programs need to demonstrate hourly active account number. Such feedback can be sent to the developer of the data report. The developer will add the feedback content in the data report when updating the data report is executed. Obviously, the data report demonstration of prior art cannot satisfy various application programs. For each application program, the demonstration possibilities seem to be few.

### SUMMARY

The embodiments of the present invention provide a data report process method and a device thereof for solving the issues that the data report of prior art which can hardly satisfy self demands of various application programs with few demonstration possibilities.

For achieving the aforesaid objective, the present invention, the following technical scheme adopted by the invention:

A data report process method, comprising:

receiving and demonstrating preset element configuration information;

receiving a configuration content selected in the element configuration information by an user;

establishing the data report, and configuring respective elements in the data report according to the configuration content, and the data report comprises index information;

obtaining data content corresponding to respective indexes in the index information according to the index information;

writing the data content in the data report.

A data report process device, comprising:

a receiving unit, receiving and demonstrating preset element configuration information;

a demonstrating unit, demonstrating the element configuration information received by the receiving unit;

the receiving unit receiving a configuration content selected in the element configuration information by an user;

the device further comprises:

an establishing unit, employed to establish a data report, and configuring respective elements in the data report according to the configuration content received by the receiving unit, and the data report comprises index information;

an obtaining unit, employed to obtain data content corresponding to respective indexes in the index information according to the index information in the data report established by the establishing unit;

a writing unit, employed to write the data content obtained by the obtaining unit in the data report.

According to the data report process method and the device thereof provided by the embodiments of the present invention, the configuration content in the element configuration information selected by an user can be received. Meanwhile, respective elements in the data report can be configured according to the configuration content after the data report is established. With the index information in the established data report, the data content corresponding to respective indexes can be obtained and written in the data report. Thereby, the data content in the data report is capable of satisfying the demands of application programs. The data reports of prior arts are all established by the developers and can hardly satisfy demands of various application programs with few demonstration possibilities. Therefore, the present invention is capable of satisfying self demands of various application programs and promoting the demonstration possibilities.

### BRIEF DESCRIPTION OF THE DRAWINGS

For more apparently explaining the skill solutions in the embodiments of the present invention and the prior arts, simple descriptions for the figures required for describing the embodiments of the present invention and the prior arts are introduced below. Obviously, the figures described here are merely some embodiments of the present invention. To those who are ordinarily skilled in the art, other figures can be derived according to these figures under the premise without creative efforts.

FIG. 1 is a flow chart illustrating a data report process method provided by an embodiment of the present invention;

FIG. 2 is a flow chart illustrating a data report process method provided by another embodiment of the present invention;

FIG. 3 is a configuration interface schematic diagram of a data report in another embodiment of the present invention;

FIG. 4 is an interface schematic diagram of a data report in another embodiment of the present invention;

FIG. 5 is a first structural schematic diagram of a data report process device provided by an embodiment of the present invention; and

FIG. 6 is a second structural schematic diagram of a data report process device provided by an embodiment of the present invention.

### DETAILED DESCRIPTION OF PREFERRED EMBODIMENTS

The present invention will now be described more specifically with reference to the following embodiments below. it is clear that the described embodiments are merely part of embodiments of the present invention, but not all embodiments cases. Based on the embodiments of the present invention, all the other embodiments obtained by those who are ordinarily skilled in the art without creative effort should belong to the protected scope of the present invention.

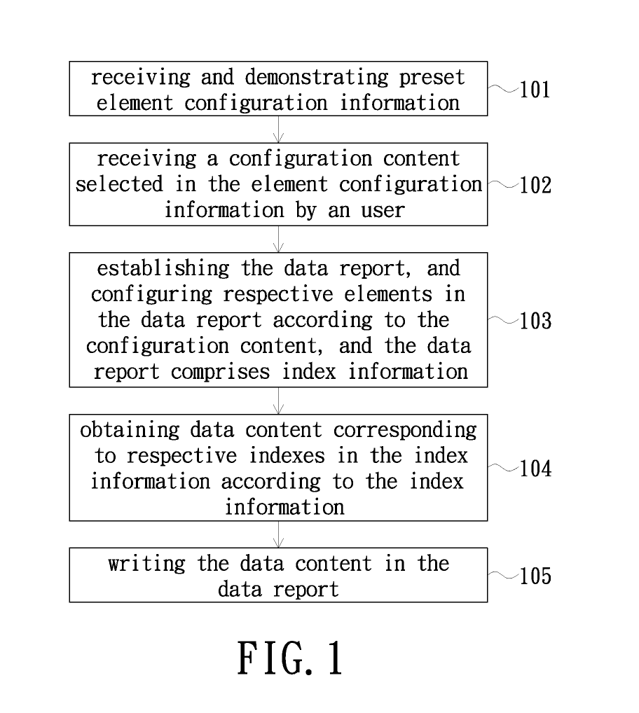

As shown in FIG. 1, a data report process method provided by an embodiment of the present invention comprises:

101. receiving and demonstrating preset element configuration information.

The element configuration information can be preset and stored in a data base. The element configuration information can comprise the index information, the dimension information, the constraint condition of index information demonstration, the calculation rule of the index information and/or the demonstrating form information corresponding to the index information.

102. receiving a configuration content selected in the element configuration information by an user.

After the element configuration information is demonstrated and the index information, the dimension information, the constraint condition of index information demonstration, the calculation rule of the index information and/or the demonstrating form information corresponding to the index information are confirmed, the index information, the dimension information, the constraint condition of index information demonstration, the calculation rule of the index information, the demonstrating form information corresponding to the index information and et cetera selected by the user can be the configuration content. For example, a setting complete button can be set. Once the setting complete button is activated, the selected configuration content can be submitted.

103. establishing the data report, and configuring respective elements in the data report according to the configuration content.

The data report comprises index information. The index information can be the name of the index items, such as the monthly active account number, the monthly highest on line account number and et cetera.

104. obtaining data content corresponding to respective indexes in the index information according to the index information.

The specific data content can come from a result data base. The data content stored in the result data base can be processed data. For instance, the source data is processed according to the element configuration information to form processed data corresponding to the element configuration information after the element configuration information is received. For example, the element configuration information comprises monthly active account number, the obtained source data is processed to obtain the monthly active account number value. The source data can be stream-oriented data as the application program is activated or the data from the record document. As an illustration, the source data records the login information and et cetera, which the user logs in the application program. The monthly active account number can be obtained from the login information when the source data is processed.

105. writing the data content in the data report.

The data report can be demonstrated and the data report comprises the data content which is required for the user after the data content is written in the data report.

According to the data report process method provided by the embodiment of the present invention, the configuration content in the element configuration information selected by an user can be received. Meanwhile, respective elements in the data report can be configured according to the configuration content after the data report is established. With the index information in the established data report, the data content corresponding to respective indexes can be obtained and written in the data report. Thereby, the data content in the data report is capable of satisfying the demands of application programs. The data reports of prior arts are all established by the developers and can hardly satisfy demands of various application programs with few demonstration possibilities. Therefore, the present invention is capable of satisfying self demands of various application programs and promoting the demonstration possibilities.

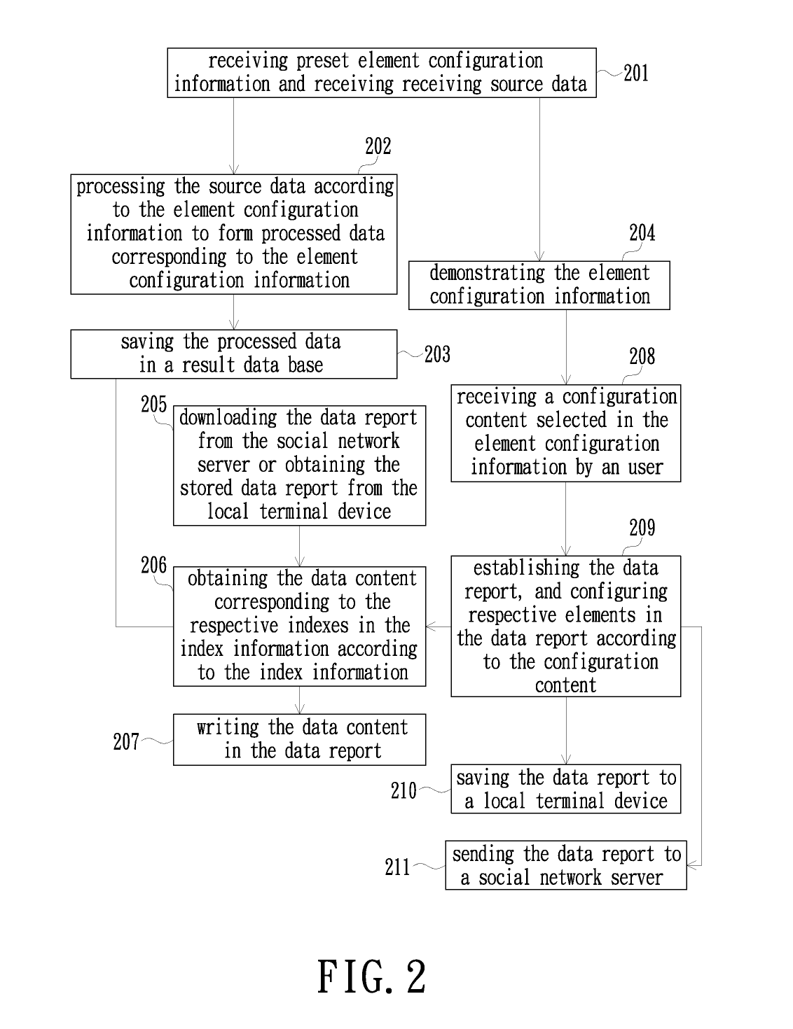

Another embodiment which is more specific is illustrated. As shown in FIG. 2, the data report process method provided by another embodiment of the present invention comprises:

201. receiving and demonstrating preset element configuration information. After step 201, step 202 and step 204 are executed. The element configuration information comprises: the index information, the dimension information, the constraint condition of index information demonstration, the calculation rule of the index information and/or the demonstrating form information corresponding to the index information. The source data can be stream-oriented data as the application program is activated or the data from the record document. For instance, the source data records the login information and et cetera, which the user logs in the application program. The monthly active account number can be obtained from the login information when the source data is processed.

The received preset element configuration information can be the index information, the dimension information, the constraint condition of index information demonstration, the calculation rule of the index information and/or the demonstrating form information corresponding to the index information which are commonly used and obtained from the data base storing the element configuration information.

Besides, the received preset element configuration information also can be received element configuration information adding instruction triggered by the user. The configuration information adding instruction comprises element configuration information to be added and the element configuration information to be added is stored in a data base employed for storing the element configuration information. Thereby, if the data base employed for storing the element configuration information does not have the element configuration information required by the application program, the element configuration information to be added of the user can be received to satisfy the demands of the application program. As an illustration, the present data report generally comprises the monthly active account number, the daily active account number and et cetera. However, some particular application program or website may require the hourly active account number. In case that the configuration information of the hourly active account number is not available in the data base employed for storing the element configuration information, the user can configure the hourly active account number himself to obtain the active account number for every sixty minutes. After the configuration is done, the configuration information of the hourly active account number also can be stored in the data base and convenient for the usage of other users to obtain the configuration information of the hourly active account number.

202. processing the source data according to the element configuration information to form processed data corresponding to the element configuration information.

For easily demonstrating the data content of the data report, every the element configuration information requires such as the corresponding processed indexes of the element configuration information, comprising: the monthly active account number, the weekly active account number, the monthly highest on line account number and etc, which the obtained source data is processed according to the monthly active account number, the weekly active account number, the monthly highest on line account number. Accordingly, the information of the monthly active account number, the weekly active account number, the monthly highest on line account number and etc can be obtained and to be demonstrated in time after the corresponding indexes are assigned. As an illustration, the user login information and etc of one application program is recorded in the source data. The monthly active account number can be obtained with the login information when the source data is processed.

203. saving the processed data in a result data base.

The data content obtained in the aforesaid step 202 can be stored in the result data base. There can be a plenty of the result data bases to form a distributed data base but not limited thereto.

204. demonstrating the element configuration information. After step 204, step 205 and step 208 are executed.

Specifically, the element configuration information can be demonstrated after the user triggered a new data report establishing instruction. Optionally, respective indexes in the index information can be demonstrated, first. After some index items are selected and then, the index information, the dimension information, the constraint condition of index information demonstration, the calculation rule of the index information, the demonstrating form information corresponding to the index information and et cetera can be demonstrated.

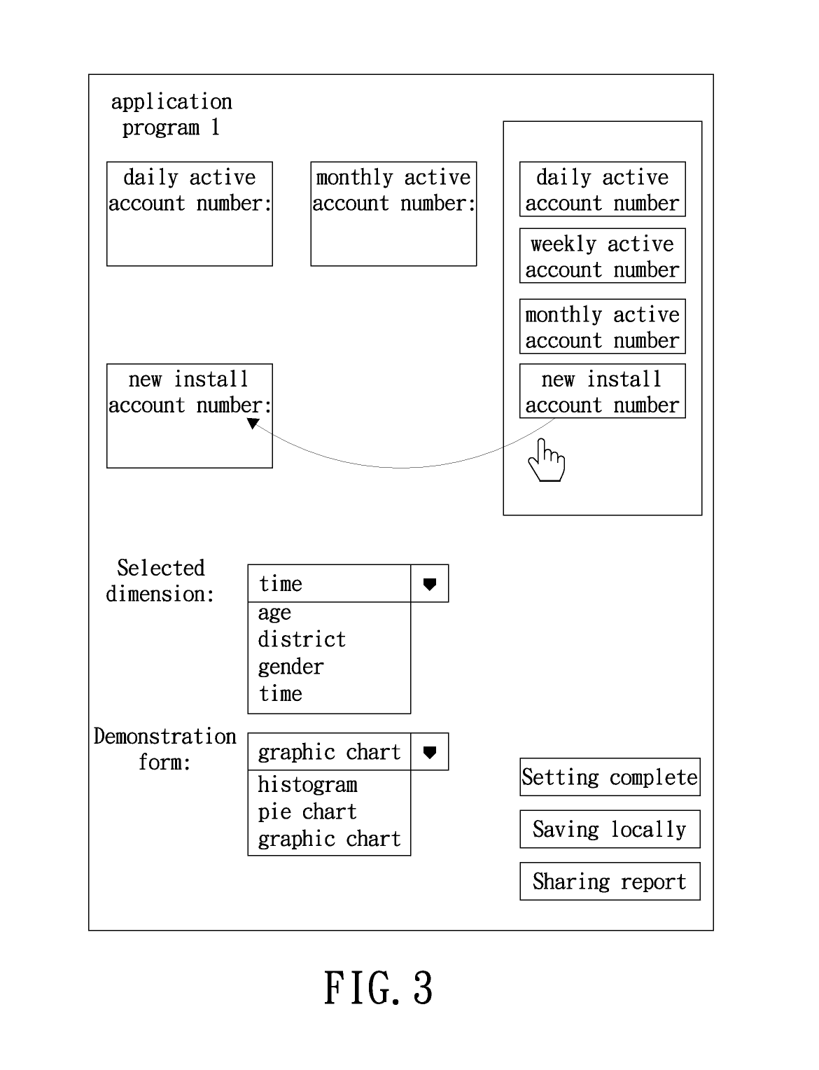

For example, as shown in FIG. 3, the data report of the application program 1 will be established after a new data report establishing instruction is triggered. Selectively, the index items, such as the daily active account number, the weekly active account number, the monthly active account number and the new install account number can be added. As an illustration, for adding the new install account number in the user interface, the icon of the new install account number can be drawn in the interface to designate the demand of demonstrating the new install account number of the application program 1. Moreover, the dimension and the demonstrating form are also can be configured. Here, mere the dimension and the demonstrating form are illustrated. Nevertheless, other indexes, such as the constraint condition of index information demonstration, the calculation rule of the index information and et cetera are also can be configured. The details are not repeated here. The dimension selected here is demonstration by time and the demonstrating form is in graphic chart.

205. downloading the data report from the social network server or obtaining the stored data report from a local terminal device.

The data report comprises the index information. After step 205, step 206 is continued to be executed.

The data report established by the element configuration information can be sent to a social network server and then can be directly downloaded and used by other data report process devices. Besides, the data report also can be saved in the local terminal device after the data report is established. The data report can be a self-defined report of the data report process device or a public report which is pre-generated as the data report product is under development.

206. obtaining the data content corresponding to the respective indexes from the processed data in the result data base according to the index information. After step 206, step 207 is continued to be executed.

Specifically, the index information can be the names of the index items, such as the monthly active account number, the monthly highest on line account number and et cetera. Besides, the index information also can be the identities of the index items but not limited thereto. With the names or the identities of the index items, the corresponding data content can be pulled out from the result data base.

207. writing the data content in the data report.

After the data content is written in the data report, the data report, which comprises the data content required by the user can be demonstrated.

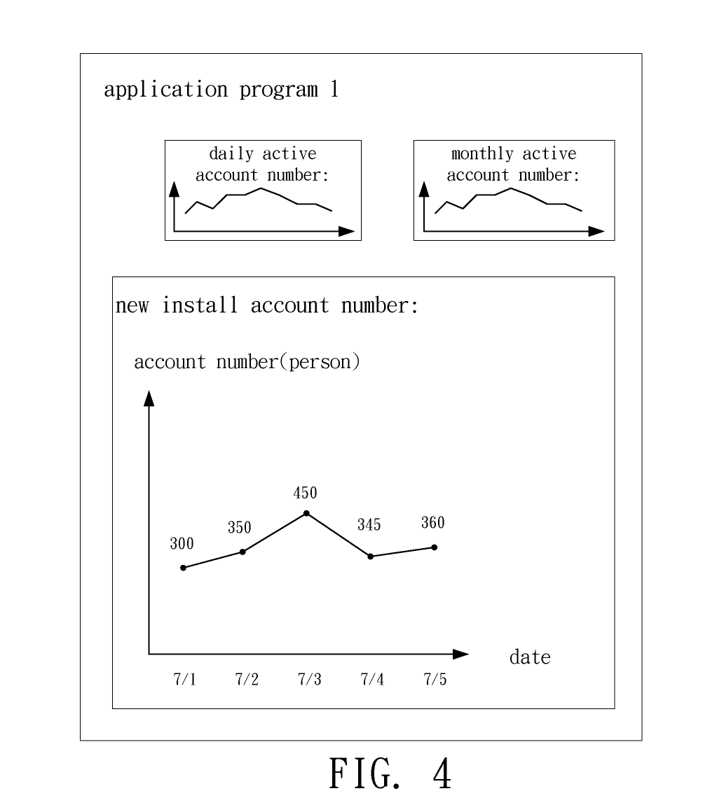

As an illustration, as shown in FIG. 4, a new install account number is demonstrated. Each value of the new install account number in July, 1-5 is demonstrated here in graphic chart. Accordingly, the demonstration of the data content in FIG. 4 is based on the configuration in FIG. 3.

Furthermore, the element configuration information can further comprise data alert condition information. The data alert condition information is employed for sending out an alert as a hint when the value of the data content demonstrated in the data report becomes larger or lesser than a predetermined threshold value or the value variance ratio of the data content exceeds a threshold value. The specific alert can be marking the data content which satisfies the data alert condition with a particular color when the data content is demonstrated or obtaining the data content which satisfies the data alert condition and demonstrating it solo. However, the present invention is not limited thereto.

208. receiving the configuration content selected in the element configuration information by the user. After step 208, step 209 is continued to be executed.

After the element configuration information is demonstrated and the index information, the dimension information, the constraint condition of index information demonstration, the calculation rule of the index information and/or the demonstrating form information corresponding to the index information are confirmed, the index information, the dimension information, the constraint condition of index information demonstration, the calculation rule of the index information, the demonstrating form information corresponding to the index information and et cetera selected by the user can be the configuration content. For example, as shown in FIG. 3, a setting complete button can be set. Once the setting complete button is activated, the selected configuration content can be submitted.

209. establishing the data report, and configuring respective elements in the data report according to the configuration content.

The data report comprises index information. After step 209, step 206, step 210 or step 211 is continued to be executed. As regarding the description of the index information, the specific description in step 206 can be referred. The details are not repeated here.

Various configuration contents, such as the index information, the dimension information, the constraint condition of index information demonstration, the calculation rule of the index information, the demonstrating form information corresponding to the index information and et cetera can be obtained after the configuration content in the element configuration information selected by the user is received. The configuration content can be arranged and formed as a configuration table. Accordingly, the respective elements can be configured according to the configuration table. For instance, as shown in Table 1 below:

TABLE 1
configuration table:

| | | | constraint condition | demon- | |
|---|---|---|---|---|---|
| Report | | Index | of index information | stration | |
| ID | Index name | ID | demonstration | form | . . . |
| 01 | new install | 001 | Older than 18 | graphic | . . . |
| | account number | | | chart | |
| 01 | monthly active | 002 | Older than 18 | histogram | . . . |
| | account number | | | | |

As an illustration, the configuration content can be arranged as Table 1, the configuration table above in accordance with the corresponding report. The data report process device can configure according to Table 1, the configuration table but not limited thereto when the data report is established.

210. saving the data report to the local terminal device.

Specifically, the data report can be saved in the local terminal device for possibly being pulled out next. For example, as shown in FIG. 3, the saving location button can be preset and once the saving locally button is clicked, the local saving path can be selected to save the data report in the saving location locally.

211. sending the data report to the social network server.

Specifically, the data report can be saved in the social network server for possibly being pulled out next. For example, as shown in FIG. 3, the sharing report button can be preset and once the sharing report button is clicked, the data report can be sent to the social network server. On the social website or the social application program belong to the social network server, the data report can be shared. Then, other accounts on the social website or the social application program can obtain the event of sharing the data report. Accordingly, the data report to be sharing among various accounts can be possible. Moreover, the social network server even can receive the comments from the users. The comments are sent by the users when the users use the social website or the social application program, i.e. comments to some index, to some dimension or to the entire data report. Accordingly, the notability of the data report shared among the various users can be obtained. As an illustration, the user can check with the data report after he selects the shared event of the data report. In some position outside the data report, grading flags and an input column can be provided in advance. The grading flags allow the users to select for grading. The comment column allows the users for wording comments. However, the present invention is not limited thereto.

Significantly, the executing subject of the data report process method provided by the embodiment of the present invention is a data report process device which can function on electronic equipments.

According to the data report process method provided by another embodiment of the present invention, the configuration content in the element configuration information selected by an user can be received. Meanwhile, respective elements in the data report can be configured according to the configuration content after the data report is established. With the index information in the established data report, the data content corresponding to respective indexes can be obtained and written in the data report. Thereby, the data content in the data report is capable of satisfying the demands of application programs. The data reports of prior arts are all established by the developers and can hardly satisfy demands of various application programs with few demonstration possibilities. Therefore, the present invention is capable of satisfying self demands of various application programs and promoting the demonstration possibilities.

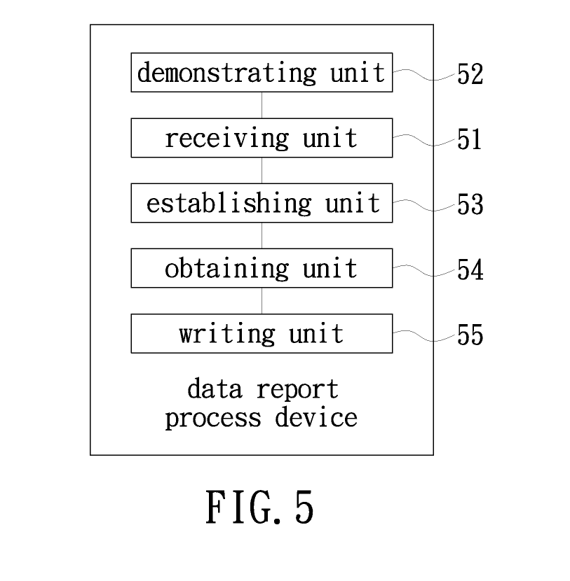

In accordance with the data report process method shown in FIG. 1 and FIG. 2, as shown in FIG. 5, the data report process device provided by the embodiments comprises:

a receiving unit 51, receiving and demonstrating preset element configuration information;

a demonstrating unit 52, demonstrating the element configuration information received by the receiving unit 51;

the receiving unit 51 is also employed to receive a configuration content selected in the element configuration information by an user;

the device further comprises:

an establishing unit 53, employed to establish a data report, and configuring respective elements in the data report according to the configuration content received by the receiving unit 51, and the data report comprises index information;

an obtaining unit 54, employed to obtain data content corresponding to respective indexes in the index information according to the index information in the data report established by the establishing unit 53;

a writing unit 55, employed to write the data content obtained by the obtaining unit 54 in the data report.

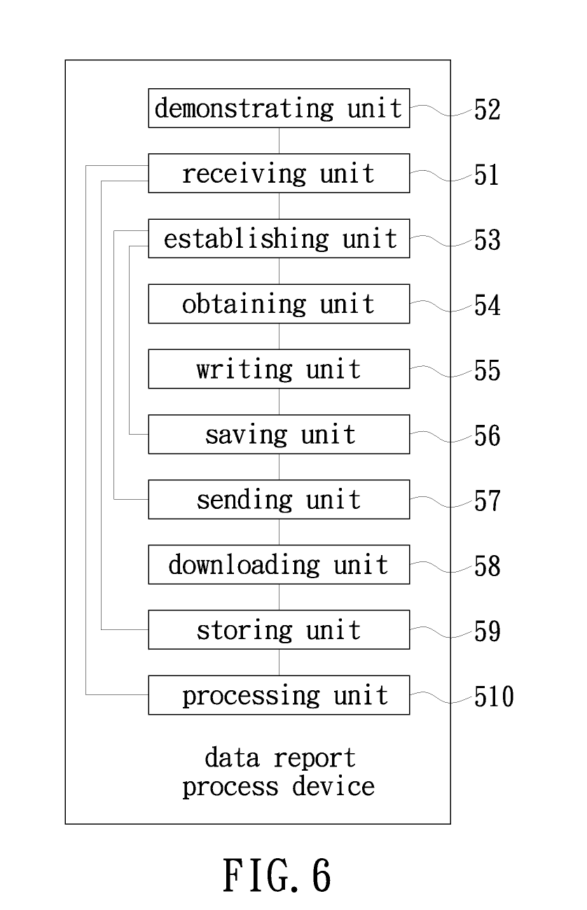

Furthermore, as shown in FIG. 6, the data report process device further comprises:

a saving unit 56, employed to save the data report established by the establishing unit to a local terminal device.

a sending unit 57, employed to send the data report established by the establishing unit to a social network server.

Moreover, as shown in FIG. 6, the data report process device further comprises:
a downloading unit 58, employed to download the data report from the social network server and the data report comprises the index information.

Besides, the receiving unit 51 is employed to receive element configuration information adding instruction triggered by the user, and the configuration information adding instruction comprises element configuration information to be added.

As shown in FIG. 6, the data report process device further comprises:

a storing unit 59, employed to store the element configuration information to be added in a data base employed for storing the element configuration information.

The receiving unit 51 is further employed for receiving source data.

The data report process device further comprises: a processing unit 510, employed to processing the source data according to the element configuration information to form processed data corresponding to the element configuration information.

The storing unit 59 is further employed to save the processed data in a result data base.

The obtaining unit 54 is employed for obtaining the data content corresponding to the respective indexes from the processed data in the result data base according to the index information.

In this embodiment, the element configuration information received by the receiving unit 51 comprises: the index information, the dimension information, the constraint condition of the index information demonstration, the calculation rule of the index information and/or demonstrating form information corresponding to the index information but not limited thereto.

According to the data report device provided by the embodiments of the present invention, the configuration content in the element configuration information selected by an user can be received. Meanwhile, respective elements in the data report can be configured according to the configuration content after the data report is established. With the index information in the established data report, the data content corresponding to respective indexes can be obtained and written in the data report. Thereby, the data content in the data report is capable of satisfying the demands of application programs. The data reports of prior arts are all established by the developers and can hardly satisfy demands of various application programs with few demonstration possibilities. Therefore, the present invention is capable of satisfying self demands of various application programs and promoting the demonstration possibilities.

Through the above description of the embodiments, persons those who are skilled in the art can clearly understand that the present invention may be achieved by means of software with a necessary universal hardware. Certainly, implementation by hardware also can be an embodiment but the former should be better under many of circumstances. Based on this understanding, the technical solution of the present invention in essence or the contributing part to the prior arts may be embodied in the form of software product. The computer software product are stored in a readable storage medium such as a computer's floppy, a hard disk or an optical disk, including several instructions for making a computer device (may be a personal computer, a server, or network equipment) to perform the method described in the embodiments of the present invention.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A data report process method, comprising:
receiving and demonstrating preset element configuration information;
receiving a configuration content selected in the element configuration information by an user;
establishing the data report, and configuring respective elements in the data report according to the configuration content, and the data report comprises index information;
obtaining data content corresponding to respective indexes in the index information according to the index information;
writing the data content in the data report.

2. The method according to claim 1, comprising:
saving the data report to a local terminal device, after establishing the data report and configuring the respective elements in the data report according to the configuration content.

3. The method according to claim 1, comprising:
sending the data report to a social network server, after establishing the data report and configuring the respective elements in the data report according to the configuration content.

4. The method according to claim 3, wherein the method further comprises:
downloading the data report from the social network server and the data report comprises the index information.

5. The method according to claim 1, wherein the method further comprises:
receiving element configuration information adding instruction triggered by the user, and the configuration information adding instruction comprises element configuration information to be added;
storing the element configuration information to be added in a data base employed for storing the element configuration information.

6. The method according to claim 5, wherein the method further comprises:
receiving source data;
processing the source data according to the element configuration information to form processed data corresponding to the element configuration information;
saving the processed data in a result data base.

7. The method according to claim 6, wherein the step of obtaining the data content corresponding to the respective indexes in the index information according to the index information comprises:
obtaining the data content corresponding to the respective indexes from the processed data in the result data base according to the index information.

8. The method according to claim 1, wherein the element configuration information comprises: the index information, dimension information, constraint condition of the index information demonstration, calculation rule of the index information and/or demonstrating form information corresponding to the index information.

9. The method according to claim 2, wherein the element configuration information comprises: the index information, dimension information, constraint condition of the index information demonstration, calculation rule of the index information and/or demonstrating form information corresponding to the index information.

10. The method according to claim 3, wherein the element configuration information comprises: the index information, dimension information, constraint condition of the index information demonstration, calculation rule of the index information and/or demonstrating form information corresponding to the index information.

11. A data report process device, comprising:
a receiving unit, receiving and demonstrating preset element configuration information;
a demonstrating unit, demonstrating the element configuration information received by the receiving unit;
the receiving unit is also employed to receive a configuration content selected in the element configuration information by an user;
the device further comprises:
an establishing unit, employed to establish a data report, and configuring respective elements in the data report according to the configuration content received by the receiving unit, and the data report comprises index information;
an obtaining unit, employed to obtain data content corresponding to respective indexes in the index information according to the index information in the data report established by the establishing unit;
a writing unit, employed to write the data content obtained by the obtaining unit in the data report.

12. The device according to claim 11, wherein the device further comprises:
a saving unit, employed to save the data report established by the establishing unit to a local terminal device.

13. The device according to claim 11, wherein the device further comprises:
a sending unit, employed to send the data report established by the establishing unit to a social network server.

14. The device according to claim 13, wherein the device further comprises:
a downloading unit, employed to download the data report from the social network server and the data report comprises the index information.

15. The device according to claim 11, wherein the receiving unit is further employed for:
receiving element configuration information adding instruction triggered by the user, and the configuration information adding instruction comprises element configuration information to be added;
the device further comprises:
a storing unit, employed to store the element configuration information to be added in a data base employed for storing the element configuration information.

16. The device according to claim 15, wherein the receiving unit is further employed for:
receiving source data;
the device further comprises:
a processing unit, employed to processing the source data according to the element configuration information to form processed data corresponding to the element configuration information;
the storing unit is further employed to save the processed data in a result data base.

17. The device according to claim 16, wherein the obtaining unit is employed for:
obtaining the data content corresponding to the respective indexes from the processed data in the result data base according to the index information.

18. The device according to claim 11, wherein the element configuration information received by the receiving unit comprises: the index information, dimension information, constraint condition of the index information demonstration, calculation rule of the index information and/or demonstrating form information corresponding to the index information.

19. The device according to claim 12, wherein the element configuration information received by the receiving unit comprises: the index information, dimension information, constraint condition of the index information demonstration, calculation rule of the index information and/or demonstrating form information corresponding to the index information.

20. The device according to claim 13, wherein the element configuration information received by the receiving unit comprises: the index information, dimension information, constraint condition of the index information demonstration, calculation rule of the index information and/or demonstrating form information corresponding to the index information.
